(19) United States
(12) Patent Application Publication
(10) Pub. No.: US 2025/0078334 A1
(43) Pub. Date: Mar. 6, 2025

(54) SYSTEM FOR OBJECT DETECTION WITH AUGMENTED REALITY INTEGRATION

(71) Applicant: Gtwerx AI, Inc., Ann Arbor, MI (US)

(72) Inventors: Ryan Michael Farris, Fairfax, VA (US); Clyde Michael Stanfield, Brighton, MI (US); Reuben Merrell Sorensen, Ann Arbor, MI (US); Timothy Allen Handy, Fort Worth, TX (US)

(21) Appl. No.: 18/814,346

(22) Filed: Aug. 23, 2024

Related U.S. Application Data
(60) Provisional application No. 63/580,812, filed on Sep. 6, 2023.

(51) Int. Cl. G06T 11/00; G06F 40/40; G06V 10/82; G06V 20/20

(52) U.S. Cl. CPC G06T 11/00; G06F 40/40; G06V 10/82; G06V 20/20; G06T 2200/24

(57) ABSTRACT

Technology is disclosed herein for part detection and augmented reality integration. A computing device displays in a user interface an image including a part. The computing device detects the part in the image and generates a parameter set based on the detection of the part in the image. In the user interface, the computing device displays an augmented reality depiction of the part overlaying the image based on the parameter set. In some implementations, to detect the part in the image, the computing device uses a neural network which is trained based on multiple images of the part in varying orientations. In some implementations, a second neural network is trained to generate a parameter set relating to the position and orientation based on the detection of the part based on parameter set data corresponding to the multiple training images.

### CROSS REFERENCE TO RELATED APPLICATIONS

This application is related to U.S. Patent Application entitled “SYSTEM FOR OBJECT DETECTION WITH AUGMENTED REALITY INTEGRATION,” Application No. 63/580,812, filed on 6 Sep. 2023, the contents of which is incorporated by reference in its entirety for all purposes.

### TECHNICAL FIELD

This relates generally to computer vision and image processing via neural networks.

### BACKGROUND

Repair, maintenance, and operation of complex systems, such as vehicles, industrial equipment, and other mechanical or electromechanical systems can be challenging for users for a number of reasons. Often, complex systems involve numerous interconnected components and subsystems, and a change made to one part may have an unintended consequence to other parts. Complex systems may require specialized knowledge for repair and maintenance that goes beyond basic understanding, including training in areas of mechanics, electronics, software, and other disciplines. For some systems, proprietary designs may require specialized knowledge or training which is not readily available to the user. So, too, can repair and maintenance involve risks such as electrical hazards, moving parts, and exposure to harmful chemicals.

Users may consult technical documentation and manuals for performing repair or maintenance procedures on a complex system. However, such documentation can be dense, difficult to interpret, or poorly organized, making it challenging for users to locate the information they need. The documentation may include drawings which are difficult to apply when facing a real, three-dimensional system, particularly if the parts are old, worn, or dirty. In some scenarios, such as restoring a classic automobile, the documentation may simply be unavailable. Moreover, if a user's level of experience or background knowledge is not aligned with the level of sophistication of the documentation, then the documentation may be of little use. Resorting to Internet searches can be helpful but also time-consuming, and the results of such searches may end up providing erroneous or conflicting information.

### SUMMARY

Disclosed herein are systems, methods, and devices for part detection and augmented reality integration. A computing device displays in a user interface an image including a part. The computing device detects the part in the image and generates a parameter set based on the detection of the part in the image. In the user interface, the computing device displays an augmented reality depiction of the part overlaying the image based on the parameter set.

In an implementation, to detect the part in the image, the computing device uses a neural network which is trained based on multiple images of the part with each image including an orientation of the part different from the other images. In some implementations, a second neural network is trained to generate the parameter set for the detection of the part based on parameter set data corresponding to the multiple training images. The parameter set may include parameters relating to the position and orientation based on the detection of the part.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an operational environment for object detection with integrated AR generation in an implementation.

FIG. 2 illustrates a method for object detection with integrated AR generation in an implementation.

FIGS. 3A and 3B illustrate operational environments for object detection with integrated AR generation in an implementation.

FIG. 4 illustrates a workflow for object detection with integrated AR generation in an implementation.

FIGS. 5A-5C illustrate training data for a neural network for object detection in an implementation.

FIGS. 6A and 6B illustrate training images for a neural network for object detection in an implementation.

FIGS. 7A-7C illustrate examples of training datasets for a generative AI model for generating procedures in an implementation.

FIG. 8 illustrates user experiences for an application including object detection with integrated AR generation in an implementation.

FIG. 9 illustrates an architecture for a computing device that may be used in accordance with some examples of the present technology.

The drawings are not necessarily drawn to scale. In the drawings, like reference numerals designate corresponding parts throughout the several views. In some examples, components or operations may be separated into different blocks or may be combined into a single block.

### DETAILED DESCRIPTION

Technology is disclosed herein for a system and methods for object detection and identification integrated with augmented reality (AR) to aid users in repair and maintenance of equipment, particularly complex systems of mechanical and/or electrical components. In an implementation, a neural network is trained to identify one or more components from real-time imagery captured by a user device and to create an augmented reality overlay which visually highlights the components in the context of stepping the user through an AI-generated repair or maintenance procedure. To perform object detection with integrated AR, a neural network is trained to detect or identify components for a given system irrespective of position, orientation, view obstruction, and surface condition of the components. In some scenarios, the system performs multiple, simultaneous detections of components, such as identifying the several bolts of an exhaust manifold.

In various implementations, an application for a system for object identification with integrated augmented reality executes on a user device with an integrated camera such as a smartphone or other computing device. As the user captures a real-time image of the system using his/her smartphone, the user submits a natural language query in the user interface relating to the repair, replacement, maintenance, or operation of parts or components of the system. For example, a user may submit a natural language query relating to replacing an air filter in the engine of a motor vehicle. The application generates a prompt for a large language model (LLM) which tasks the LLM with generating a procedure including multiple steps for accomplishing the job of replacing the air filter as referenced in the user's query.

In various implementations, the LLM which generates the multi-step procedure is trained for performing such tasks using materials such as manufacturer documentation, owners' manuals, and other resources relating to the system from which a training set of sample queries and completions are generated. Based on its training, the LLM generates the procedure which is then processed by a trained natural language processor to create an AR-augmented guide for display in the user interface of the application. The natural language processor is trained to translate the natural language output of the LLM into actionable steps of an AR-augmented guide.

Continuing the exemplary implementation, as the user aims the camera of his/her device at the engine compartment, the AR-augmented guide displays a text-based description of each step of the multi-step procedure for replacing the air filter based on the procedure by the LLM, such as the steps detailing which components must be removed to access the filter, the removal and replacement of the air filter, and then reassembling the components. At various steps in the guide, as the user aims the device camera at the engine, parts which are referenced in the current step are identified by a trained neural network executed by the application and highlighted on the image using a bright-line AR overlay outlining the referenced parts. Thus, the user is guided through the repair or maintenance process with text-based instructions and a visual indication of the part(s) to which the instructions refer.

In various implementations, the vehicle or engine which is to be repaired may be identified by the user keying in, for example, the make, model, and year of the vehicle or the particular engine. In some implementations, however, vehicle or engine identification may be performed by an artificial neural network trained for system identification based on real-time imagery captured by the user device.

In various implementations, an artificial neural network is trained to detect or identify parts of an engine using training data rendered from a three-dimensional (3D) model of the engine. The 3D model may be a digital representation of the part (e.g., in a .obj file) captured by a 3D scan of the object or from a computer-aided design (CAD) of the part. To generate the training data, two-dimensional (2D) images of a part are captured from the 3D model in a variety of orientations (e.g., 64 orientations) with each image depicting the part in a generic way (e.g., without variation in color). Edge shading and/or surface contouring is added to or heightened in the images to indicate depth associated with the three-dimensionality of the part. The generic set forms the ground truth data for training the neural network. For each image in the ground truth data set, a parameter set is generated which includes parameters relating to the position or location (e.g., 3D coordinates) and orientation (e.g., roll, pitch, yaw angles) of the part. In some implementations, the parameter set may include part size or dimension data.

To create the training data set, controlled variability in elements which may confound the neural network model is added to the generic images. For many of the training images, a noisy background is added to train the model to distinguish the part from its surroundings. To further improve the ability of the neural network to identify or detect the part, in some images, portions of the part are obscured by superimposing the image of another object or a grid on the image. In addition, in the training images, surfaces of the parts may be flattened with respect to texture or neutralized with respect to color to reduce any reliance on surface color or condition of the part during part identification. For parts with generic shapes (e.g., a car battery in the form of a rectangular volume), one or more distinguishing features such as a product label, bar code, or UPC code may be included in some of the training images to aid in detection or identification. By rendering the training images in different ways, the neural network is trained to identify a part from a wide variety of viewpoints which may be partially obscured or against a complicated background regardless of color or condition.

During the training phase, the neural network generates a parameter set for the part based on position or location (e.g., 3D coordinates) and/or orientation (e.g., roll, pitch, yaw angles) data detected from the training images of the part. To train the model, a loss/cost function is computed based on comparing the parameter set for the parts depicted in the training images to the parameter set of the corresponding ground-truth image. The weights and biases of the neural network model are refined to minimize the loss/cost function.

At run-time, when the user aims the device camera in the location of a part for a step in the repair guide, the application receives and processes the real-time imagery to enhance contrast and reduce specular lighting effects. The application detects the part indicated in the guide and generates a virtual bounding box to localize the part which allows a parameter set including position and orientation parameters of the part to be determined. Based on the parameter set determined for the real-time image, the application generates an augmented reality outline or silhouette for the part which is displayed over the part image in the user interface. In various implementations, the application executes the trained neural network model to detect multiple parts in captured imagery and display multiple silhouettes simultaneously.

In some implementations, a neural network may be trained to identify a part based on images of multiple different types or versions of the part. For example, a variety of images of distributor caps from different car models and/or manufacturers may be used to train the model to identify a distributor cap which was not specifically included in the training set.

In some implementations, where a part is to be replaced, the application may present a link to the user to purchase the replacement part, ensuring that the correct part is purchased.

Technical effects of the technology enclosed herein include generating an interactive guide which steps a user through a procedure for repair, maintenance process, or an equipment operating which provides information to the user based on the particular vehicle, engine, device, system, etc. Because the application can identify the vehicle, engine, device, or system the user is working on without input from the user, the application ensures that the correct guide is provided in response to the user's natural language query, eliminates the need to search instruction manuals, owners' guides, or Internet resources for the necessary information, and circumvents the need for the user to frame his/her question in prescribed way. Moreover, the neural network model is trained for suboptimal imaging scenarios (e.g., low-light situations, low-contrast images) as well as for variability in the appearance of parts to improve the model's success of part identification.

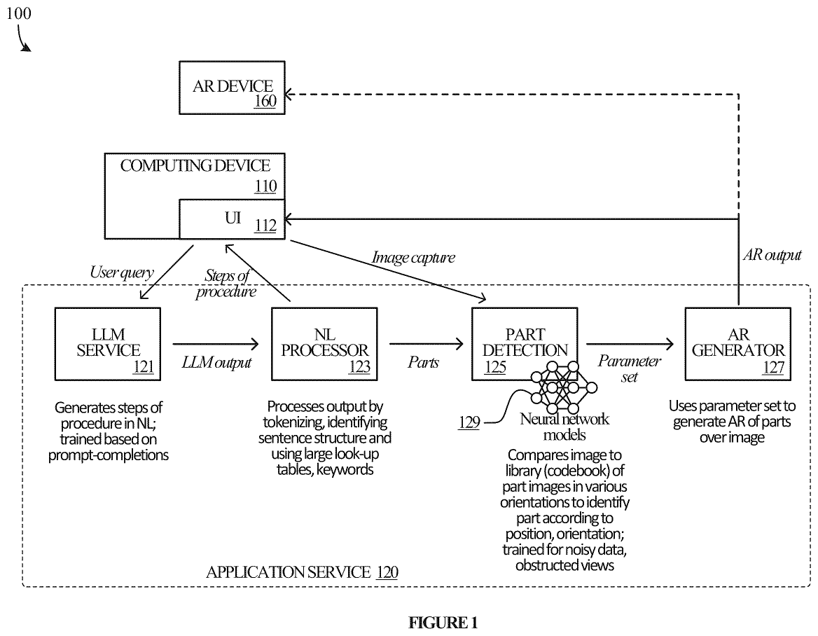

Turning now to the figures, FIG. 1 illustrates operational environment 100 for parts identification with integrated AR capability in an implementation. Operational environment 100 includes computing device 110 including user interface (UI) 112 which receives user input such as natural language queries and displays images captured by a camera (not shown) operatively coupled to computing device 110. Application service 120 includes components of operational environment 100 include large language model (LLM) service 121, natural language (NL) processor 123, part detection module 125, and augmented reality (AR) generator 127. Part detection module 125 is communicatively coupled to neural network 129 which performs computer vision (CV) tasks. Output from AR generator 127 is transmitted to computing device 110 for display in UI 112. In some implementations, output from AR generator 127 is transmitted to AR device 160.

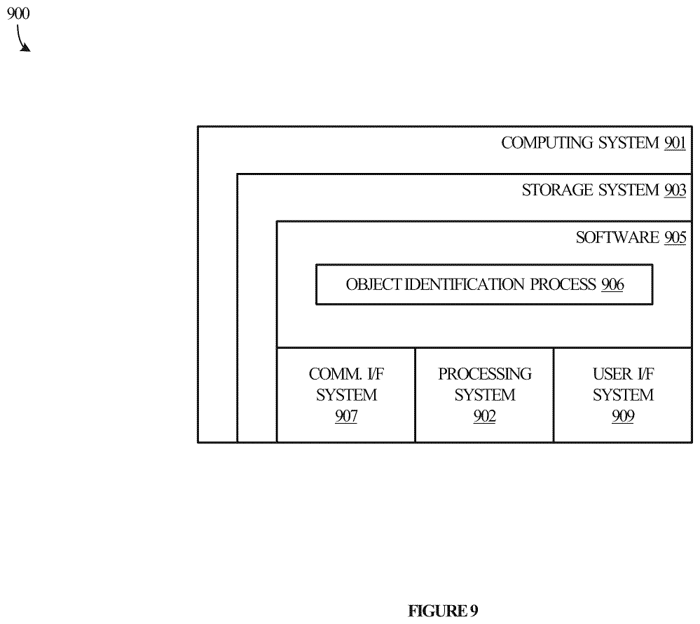

Computing device 110 is representative of computing devices, such as laptops or desktop computers, mobile computing devices, such as tablet computers or cellular phones, and any other suitable devices of which computing device 901 in FIG. 9 is broadly representative. Computing device 110 communicates with application service 120 via one or more internets and intranets, the Internet, wired or wireless networks, local area networks (LANs), wide area networks (WANs), and any other type of network or combination thereof. A user interacting with computing device 110 submits a user query to application service 120 via UI 112. Computing device 110 transmits to part detection module 125 images captured by a camera or sensor device (not shown) operatively coupled to computing device 110. Computing device 110 receives and displays output generated by application service 120 in UI 112.

In various implementations, application service 120 is representative of one or more computing services capable of interfacing with computing device 110. Application service 120 may be implemented in software in the context of one or more server computers co-located or distributed across one or more data centers. Examples of such servers include web servers, application servers, virtual or physical servers, or any combination or variation thereof, of which computing device 901 in FIG. 9 is broadly representative. Application service 120 may communicate with computing device 110 via one or more internets, intranets, the Internet, wired and wireless networks, LANs, WANs, and any other type of network or combination thereof.

LLM service 121 is representative of one or more computing services capable of hosting a foundation model or LLM computing architecture and communicating with application service 120. LLM service 121 may be implemented in the context of one or more server computers co-located or distributed across one or more data centers. LLM service 121 hosts an LLM which is representative of a deep learning AI model, such as GPT-3®, GPT-3.5, ChatGPT®, or GPT-4, BERT, ERNIE, T5, XLNet, or other foundation model. LLM service 121 interfaces with a prompt engine (not shown) of application service 120 to receive prompts associated with a user query from computing device 110 and to return natural language output generated by the LLM to NL processor 123 for further handling.

NL processor 123 is representative of one or more computing services capable of receiving and processing the natural language output of LLM service 121 and processing the output to generate a procedure for performing tasks responsive to the user query. To configure the procedure, NL processor 123 parses the output and identifies a sequence of steps the user is to perform. NL processor 123 transmits the steps of the procedure to computing device 110 for display in UI 112. The steps may indicate an action that the user is to perform on a part of a system which is the subject of the user query. NL processor 123 also transmits a request to part detection module 125 to identify various parts indicated in the output from LLM service 121. In some implementations, the LLM of LLM service 121 is a fine-tuned LLM trained with a prompt-completion dataset, where the prompts are samples of natural language queries that users would submit relating to a particular mechanical system and completions responsive to the prompts which are indicative of the type of output the LLM is to generate.

Part detection module 125 is representative of one or more computing services capable of receiving a request to detect a part in an image captured by a computing device, such as computing device 110. Part detection module 125 is operatively coupled to one or more neural network models 129 which perform the part detection and returns output including a set of parameters which identifies the location and orientation of the part. Part detection module 125 sends the parameter set of the detected part to AR generator 127.

AR generator 127 is representative of one or more computing services capable of receiving a parameter set, generating an AR depiction of a part, and transmitting the AR depiction to computing device 110 for display. AR generator 127 receives the parameter set of a detected part from part detection module 125 or from neural network models 129. In some implementations, AR generator 127 may transmit an AR depiction of the detected part to AR device 160 for display.

AR device 160 is representative of a device, such as AR goggles, capable of receiving an AR depiction of a part generated by AR generator 127 and displaying the depiction to a user. In some implementations, AR device 160 is operatively coupled to computing device 110.

In a brief example of the technology disclosed herein, a user submits a natural language query relating to a mechanical system to application service 120 via UI 112. The mechanical system can include a system for which a user may wish to perform a task, such as a vehicle (e.g., an automobile, drone, etc.) or other type of system (e.g., a manufacturing system, weapons system, etc.). The user query relates to performing a task, such as a repair, a maintenance operation, a part replacement, or operation of the mechanical system.

Application service 120 receives the query and generates a prompt for LLM service 121 based on the query. A prompt engine (not shown) of application service 120 generates the prompt based on a prompt template identified according to information received from the user, such as the type of mechanical system, the type of information requested, and so on. The prompt template may include rules or instructions which task the LLM of LLM service 121 with generating its output in a particular manner, such as a sequence of actions or tasks the user is to perform. The prompt template may also specify a parse-able format for the output from the LLM. The prompt engine includes the natural language query in the prompt and submits the prompt to the LLM.

LLM service 121 receives the prompt and generates output based on the prompt. The output includes a sequence of steps to be performed to accomplish the task indicated in the user query. The steps may include one or more parts of the mechanical system which are the subject of some action the user is to take, such as a part that is to be removed. LLM service 121 sends the output generated by the LLM to NL processor 123.

Upon receiving the output from LLM service 121, NL processor 123 processes the output to generate a sequence of steps for display in UI 112 for the user to perform. NL processor 123 parses the output to identify parts indicated in the steps which are to be detected and highlighted in UI 112 as the user steps through the procedure. NL processor 123 transmits the parts indicated in the procedure to part detection module 125.

Part detection module 125 receives parts for which an AR outline or silhouette is to be generated as the user steps through the procedure. Part detection module 125 inputs imagery received from computing device 110 to neural network module 129 which detects the requested part and generates a parameters set based on the part detection in the imagery. Part detection module 125 sends the parameter set to AR generator 127 which generates an AR silhouette depicting the detected part and transmits the AR silhouette to computing device 110 for display in UI 112.

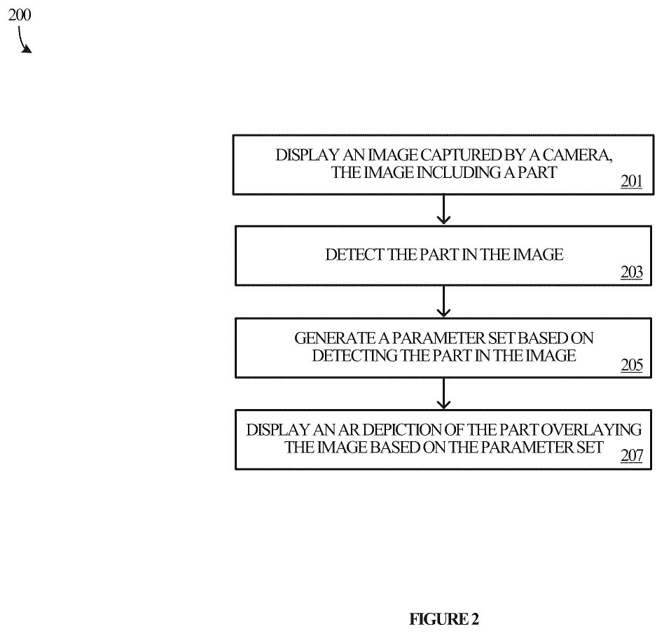

FIG. 2 illustrates process 200 for object detection with integrated AR display in an implementation. Process 200 may be implemented in program instructions in the context of software applications, modules, components, or other elements of one or more suitable computing devices, of which computing device 901 of FIG. 9 is representative. The program instructions direct the computing device(s) to operate as follows, referring parenthetically to the steps of FIG. 2 and in the singular for the sake of clarity.

A computing device displays an image captured by a camera which includes a part to be detected in the image (step 201). In an implementation, a camera receives an image of a mechanical system on which a procedure is to be performed. A step in the procedure indicates a part of the mechanical system which is the subject of some action the user is to take, such as a part which is to be removed, replaced, cleaned, oiled, etc. The image may be processed to enhance contrast and to reduce specular lighting effects which might interfere with the ability of the neural network to detect the part or parts of interest.

The computing device detects the part in the image (step 203). In an implementation, the computing device inputs the captured image to a neural network trained for part detection. The data used to train the neural network includes a library of codebooks for each of the parts which are indicated in a procedure. Each codebook includes images of a part from a variety of viewpoints rendered from a 3D model of the part. The images in the codebooks are processed prior to training to enhance contrast and heighten contour shading. The images in the codebook are subject to controlled variability by the introduction of confounding factors such as noisy backgrounds, blurriness, and occluded views. In an implementation, the neural network generates a perimeter or bounding box around the part in the image, creating a localized subset of the image which is used to identify the position and orientation of the part.

The computing device generates a parameter set based on the detection of the part in the image (step 205). In an implementation, based on the part of interest as detected in the captured image or in the bounding box in the captured image, a second neural network generates a parameter set or encoding in accordance with its training. The encoding includes parameters which relate to the position of the part (i.e., 3D coordinates) in the image along with its orientation (i.e., roll, pitch, and yaw angles). The training data used to train the second neural network includes image data similar to or the same as the training data for the neural network for part detection but also includes parameter sets for each of the part images. The parameter sets of the training images are unique to each image and are used to train the neural network to generate a parameter set of a detected part in the captured image. The second neural network processes the captured or bounded image to generate an encoding which describes the position and orientation of the requested part based on its training.

Based on the parameter set, the computing device displays an AR depiction of the part overlaying the image (step 207). The AR depiction provides a visual indication to the user of which part is the subject of the current step of the procedure. In an implementation, the AR depiction is generated according to the position and orientation parameters of the parameter set of the depicted part. The AR depiction may be generated as a highlighted outline of the part which overlays the part in the image. In some implementations, the computing device may generate and simultaneously display AR outlines or silhouettes for multiple parts which are indicated in a single step of the procedure.

Referring again to FIG. 1, operational environment 100 includes a brief example of process 200 as employed by elements of operational environment 100 in an implementation. In brief example of operations in operational environment 100, a user wishes to replace a water pump in his/her vehicle. The user enters information in UI 112 which identifies the make, model, year, and engine type of the vehicle. In some implementations, the user captures an image of the vehicle and/or its engine compartment, and a specially trained neural network (not shown) for engine or vehicle identification identifies the engine or vehicle. The user submits a natural language query for information on replacing a water pump in a vehicle. The query is submitted in UI 112 on computing device 110, such as the user's smartphone. Computing device 110 submits the query to application service 120.

Upon receiving the query, a prompt engine (not shown) of application service 120 generates a prompt and submits the prompt to LLM service 121. The prompt includes rules or instructions which task the LLM of LLM service 121 with generating a sequence of steps for replacing the water pump for the user's particular vehicle and/or engine. The prompt may task LLM service 121 with returning the output in a particular format, such as a JSON object with numbered steps which steps through the replacement procedure. The steps are in a text-based natural language format with each step indicating a task or instruction for the user to perform to replace the water pump. LLM service 121 submits the output generated by the LLM to NL processor 123 of application service 120.

NL processor 123 receives the output from LLM service 121 including a sequence of steps for replacing the water pump. NL processor 123 tokenizes the output by breaking down the text of the output into smaller units (tokens), which can include words, phrases, or characters. NL processor 123 then assigns grammatical tags to the tokens to indicate the syntactic category of the token (e.g., noun, verb, adjective) and uses the roles of the tokens in their respective sentences or phrases to determine a grammatical structure of the text. To parse the output, NL processor 123 analyzes the grammatical structure of the text to understand relationships between the words or tokens, such as subject-verb relationships or noun phrases. Based on the parsed output, NL processor 123 displays the steps of the procedure in UI 112 and requests an AR depiction of the various parts indicated in the steps to part detection module 125. In displaying the steps, NL processor 123 may identify particular tools needed at each step and generate a graphical display of the tool for the user's convenience.

Part detection module 125 receives the requests for AR depictions for various steps of the procedure from NL processor 123. Part detection module 125 also receives real-time imagery captured by a camera onboard computing device 110 of the engine compartment. Using neural network models 129, part detection model 125 identifies the location of a given part for a step of the sequence, for example, identifying the alternator for removal. Part detection module 125 identifies the alternator in the captured image and generates a parameter set for the detected image. Part detection module 125 sends the parameter set to AR generator 127 to generate an AR outline of the alternator for display in UI 112.

AR generator 127 receives the parameter set for the detected alternator image and generates an AR depiction of the alternator for overlay on the captured image of the engine compartment. The AR depiction may include an outline of the alternator in a bright and highly contrasting line to visually distinguish the part. AR generator 127 transmits the AR depiction to computing device 110 for display in UI 112 for the step which is associated with the depiction.

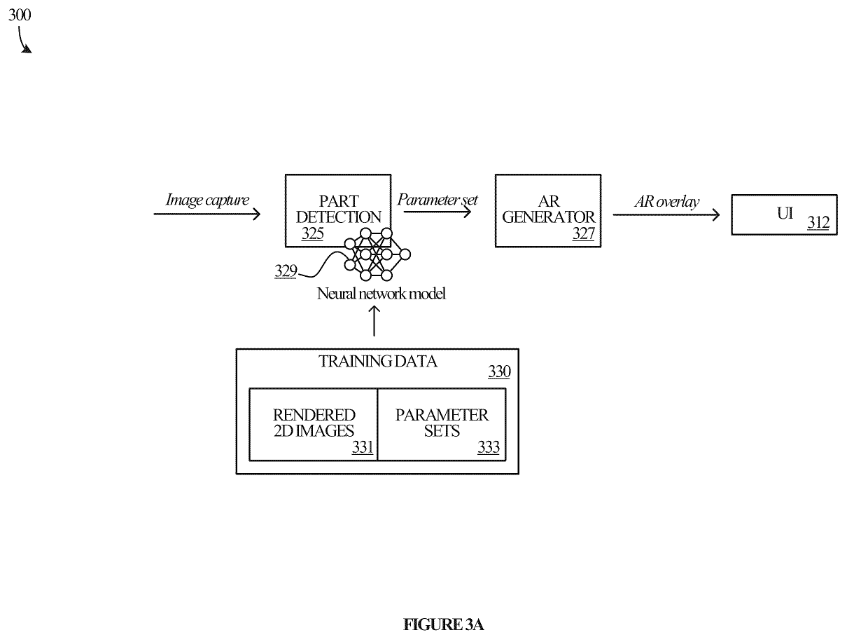

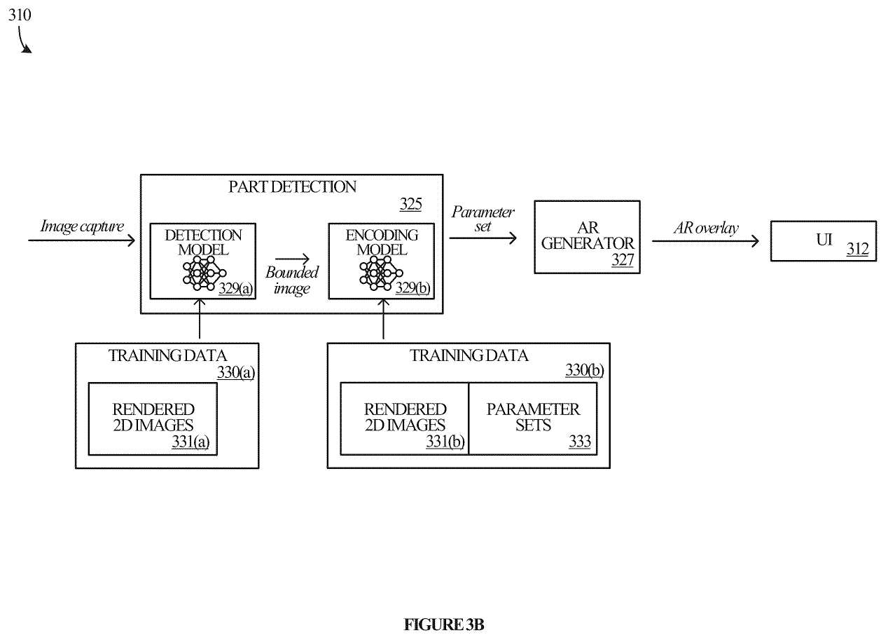

FIGS. 3A and 3B illustrate an operating environments for part identification with an integrated augmented reality depiction in an implementation. Operational environments 300 and 310 of FIGS. 3A and 3B includes components of an application service, of which application service 120 of FIG. 1 is representative, which receives a request for a part detection or identification and an AR depiction of the part on a captured image.

In operational environment 300 of FIG. 3A, part detection module 325 is representative of a service for detecting a part and generating a parameter set for the detected part. Part detection module 325 includes neural network model 329 which is trained for part detection and parameter set generation based on training data 330. Part detection module 325 communicates with AR generator 327 by sending parameter sets for the depicted parts.

AR generator 327 is representative of a service for generating an AR depiction for a detected part based on a parameter set, such as a parameter set for detected part received from part detection module 325. The AR depiction generated based on a parameter set is transmitted to UI 312 executing a computing device (not shown) such as a smartphone.

Neural network model 329 is representative of an AI service or platform trained or fine-tuned for detecting a part in a captured image from a computing device. Neural network model 329 may be implemented in the context of one or more server computers co-located or distributed across one or more data centers.

In a brief operational example of the elements of operational environment 300 of FIG. 3A, neural network model 329 is trained using training data 330 which includes 2D images 331 of various parts of a mechanical system. For each part, several 2D images of the part are rendered from a 3D model, a 3D scan of the physical part, or a CAD representation of the part. Each image is taken from a different orientation or viewpoint of the part to train neural network model 329 to detect the part from many different camera positions. At least a subset of 2D images 331 includes a noisy background added to the image to train neural network model 329 to recognize the part in situ, such as installed in an engine compartment. At least a subset of 2D images 331 also includes obstructions or occlusions superimposed atop the images of the parts to train neural network 329 to detect a part when it is not completely visible.

Training data 330 also includes parameter sets 333 which are generated for and keyed to each image of 2D images 331. Parameter sets 333 including parameters relating to the position or location of the depicted part in 3D coordinates as well as orientation information—roll, pitch and yaw angles—of the part as depicted in the image. Because of the variability in how the part is imaged in 2D images 331, the parameter set for each image is distinct.

In a brief operational example of the elements of operational environment 310 of FIG. 3B, part detection module 325 includes two neural network models, detection model 329(a) and encoding model 329(b), each of which performs an aspect of detecting a part in a captured image and generating an encoding or parameter set which describes the orientation and position of the detected part for AR generation.

In operation, detection model 329(a) receives an image captured by the user device and detects a part, such as a part indicated by an application service or a natural language processor of an application service. Detection model 329(a) generates a perimeter, such as a rectangular “bounding” box, which surrounds the requested or detected part and, much like a zoom lens on a camera, zooming in on the part to minimize the background and draw emphasis to the part in the image. The bounded portion of the captured image is transmitted to encoding model 329(b) for encoding. Transmitting the bounded image of the part allows encoding model 329(b) to focus on the detected part to detect its orientation and position without distractions or other confounding elements from the background.

Detection model 329(a) is trained based on training data 330(a) to detect various parts or components based on 2D images 331(a) and to generate output including a perimeter (e.g., a bounding box) of the part in the captured image. Similar to 2D images 331 of FIG. 3A, training data 330(a) includes 2D images 331(a) of the parts from 3D scans or models or CAD representations of the parts and rendered in various orientations, positions, and obstructions to make detection model 329(a) more robust in its part detection.

Continuing the operational example, encoding model 329(b) receives the bounding box portion of the captured image and detects or identifies, based on its training, the orientation and position of the part. Encoding model 329(b) encodes the orientation and position of the detected part in the captured image in a parameter set which is transmitted to AR generator 327.

Encoding model 329(b) is trained using training data 330(b) which includes 2D images 331(b) of various parts of a system. For each part, several 2D images of the part are rendered from a 3D model, a 3D scan of the physical part, or a CAD representation of the part. Each image is taken from a different orientation or viewpoint of the part to train neural network model 329 to detect the part from many different camera positions. At least a subset of 2D images 331(b) includes a noisy background added to the image to train neural network model 329 to recognize the part in situ, such as installed in an engine compartment. At least a subset of 2D images 331(b) also includes obstructions superimposed atop the images of the parts to train encoding model 329(b) to detect a part when it is not completely visible.

Training data 330(b) also includes parameter sets 333 which are generated for and keyed to each image of 2D images 331(b). Parameter sets 333 including parameters relating to the position or location of the depicted part in 3D coordinates as well as orientation information—roll, pitch and yaw angles—of the part as depicted in the image. Because of the variability in how the part is imaged in 2D images 331(b), the parameter set for each image is distinct.

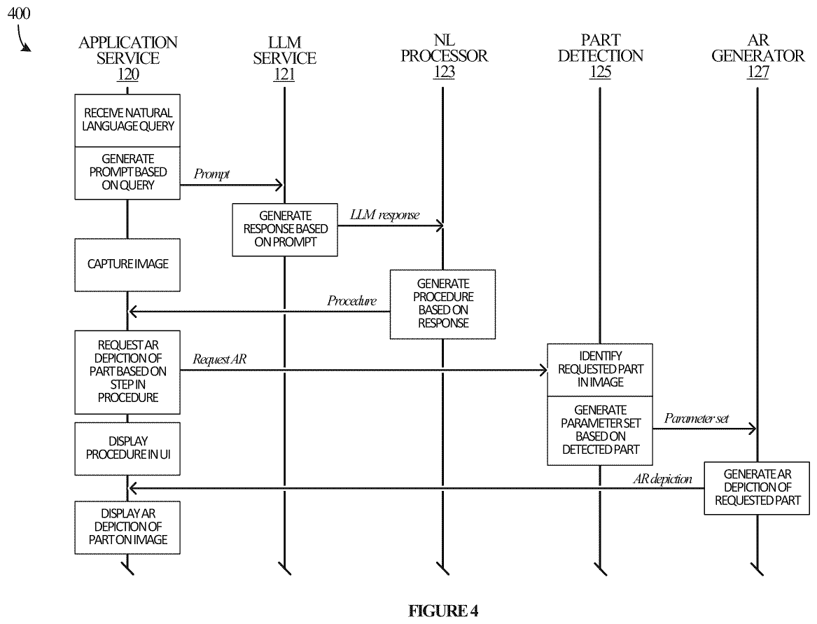

FIG. 4 illustrates workflow 400 for part detection with augmented reality depiction referring to elements of operational environment 100 in an implementation. In workflow 400, application service 120 receives from a computing device a natural language query relating to a mechanical system. Application service 120 generates a prompt for LLM service 121 based on the query and submits the prompt to LLM service 121.

Upon receiving the prompt, an LLM of LLM service 121 generates a response which includes a sequence of steps for a procedure which is responsive to the user's query. LLM service 121 sends the response of the LLM to NL processor 123. NL processor 123 processes the output to generate a sequence of instructions for display on the user computing device. Application service 120 receives the sequence of instructions and generates a request for part detection module 125 for an AR depiction of various parts as indicated in the instructions. In some implementations, NL processor 123 sends the request for AR depictions to part detection module 125 directly based on the parsed output.

For a given part in the sequence of instructions, part detection module 125 receives the request for an AR depiction of the part and uses one or more neural networks trained to recognize the part to detect the part in an image captured by the user computing device and generate a parameter set which describes the orientation and position of the part in the image.

In an implementation, a detection model, such as detection model 329(a) of FIG. 3B, of part detection module 125 generates a rectangular perimeter which bounds the detected part and transmits the bounded portion of the image to a second, encoding model of part detection module 125 for parameter generation. With the part identified in a bounded portion of the captured image, the encoding model, such as encoding model 329(b) of FIG. 3B, generates a parameter set for the part localized in the bounding box. The parameter set includes parameters which indicate the orientation and position of the part in the detected image. Part detection module 125 transmits the parameter set to AR generator 127.

Upon receiving the parameter set, AR generator 127 configures an AR depiction of the part to overlay on the captured image. AR generator 127 transmits the AR depiction, such as an image file or instructions for generating the depiction, to application service 120. Application service 120 generates the AR depiction of the part on the captured image.

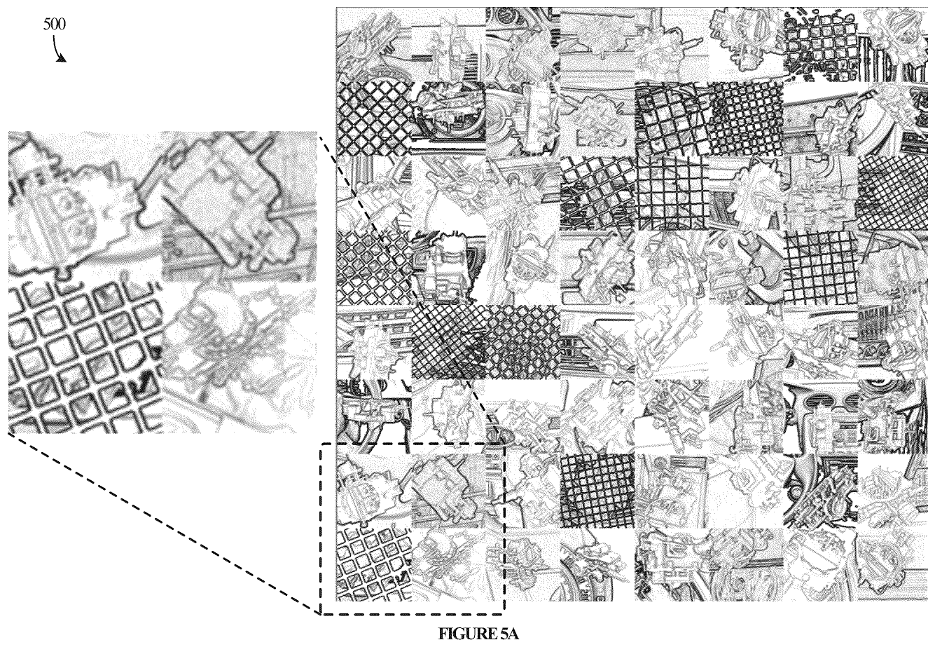

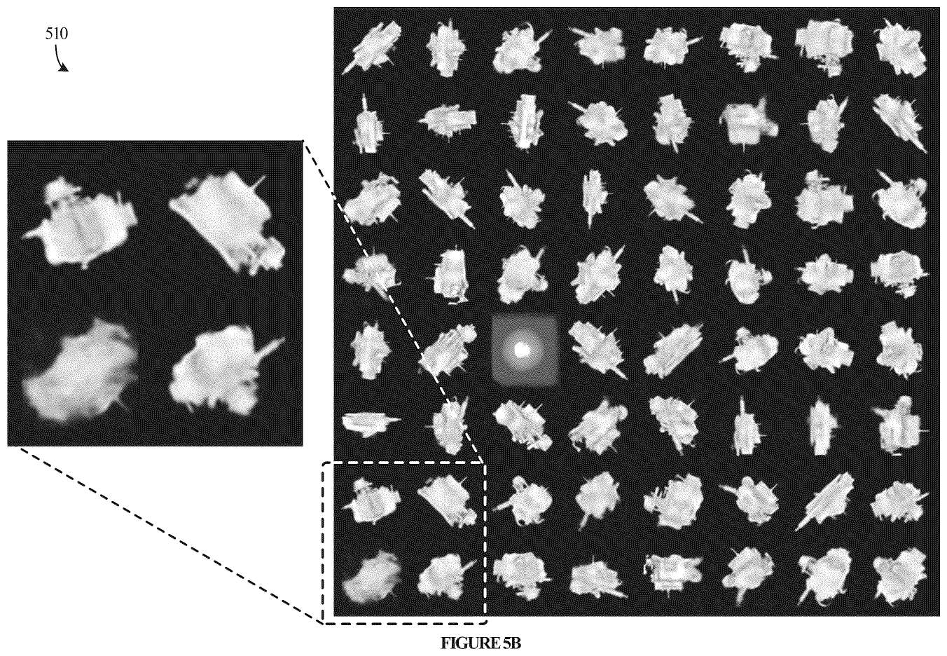

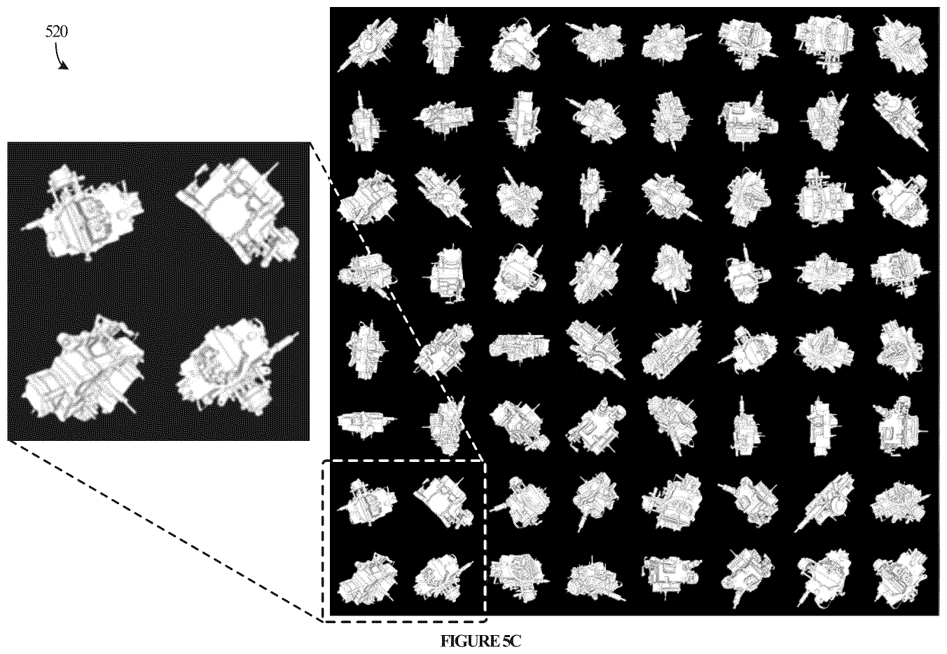

FIGS. 5A, 5B, and 5C illustrate images of a part (specifically, a carburetor of a 1967 Mustang) at various stages of training a neural network for part detection. Array 500 includes 64 different images of a part rendered in 2D from a 3D representation of the part. In an implementation, to generate the training images in array 500, ground-truth images illustrated in array 520 of FIG. 5C are modified to introduce variability in how the neural network might encounter the part in an image. For variability, the images in arrays 500 and 520 include the part in a variety of orientations and positions. The images also include a variety of noisy backgrounds, and a subset of the images illustrate an obstructed view of the part.

The images of array 500 are representative of image data which may be used to train a neural network model for detecting a part in an image received from a user computing device and generating a perimeter which defines a subset of the image by bounding the part in the image. The images of array 500 are also representative of image data which may be used to train a neural network model for detecting the position and orientation of the part detected in the bounded image and generating a parameter set or encoding which includes data which describe the position and orientation of the detected part.

Array 510 of FIG. 5B illustrates the position and orientation identifications of the part generated by an encoding model or neural network as it is being trained to identify the position and orientation of a part, with each image in array 510 corresponding by array position to a training image in array 500. To train the neural network model, the detections illustrated in array 510 are compared to ground truth images in array 520 of FIG. 5C.

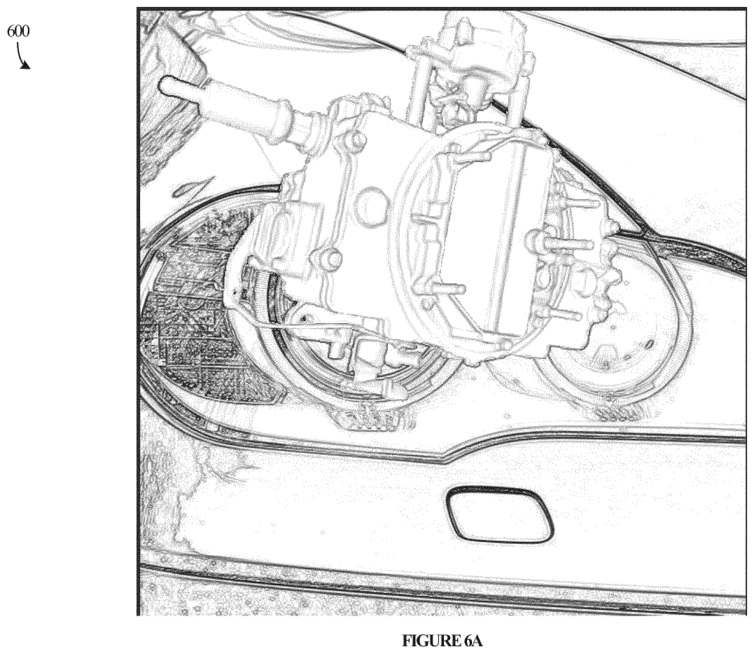

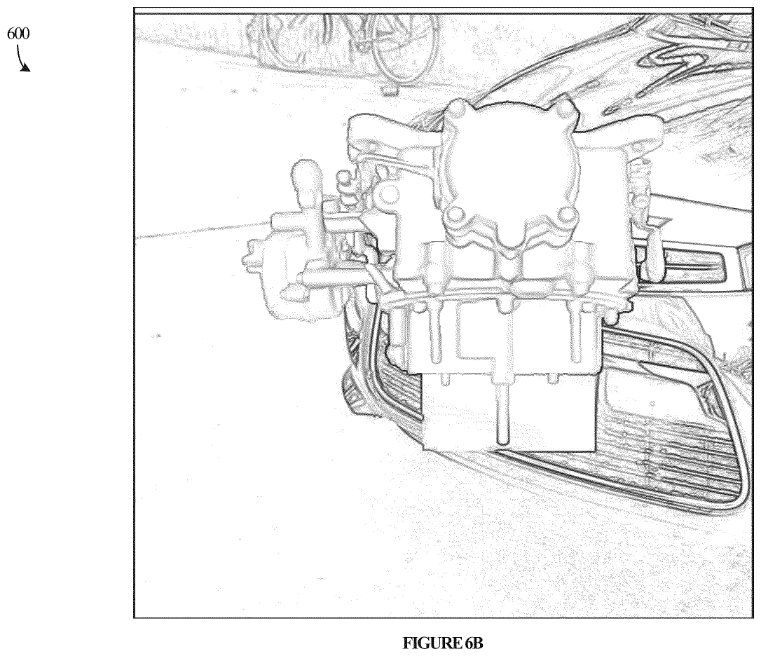

FIGS. 6A and 6B illustrate training images 600 and 610 which include close-up views of the part illustrated in FIGS. 5A-5C (carburetor for a 1967 Mustang). In training images 600 and 610, the carburetor is depicted against a noisy background and at random orientations or perspectives and positions in the images. The surfaces of the carburetor are neutralized or flattened with respect to color and texture, while the shape of the carburetor is enhanced by the addition of shaded contouring and heightened contrast.

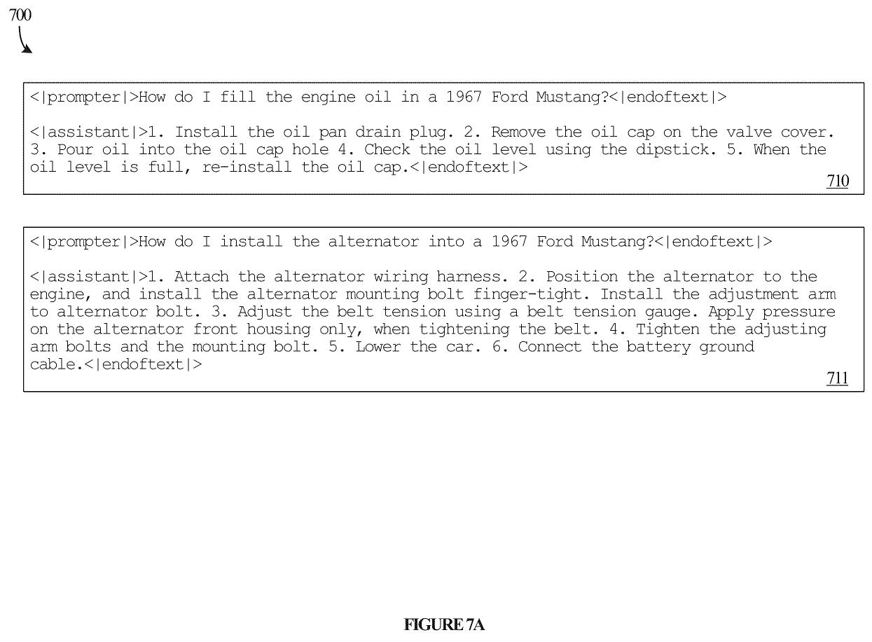

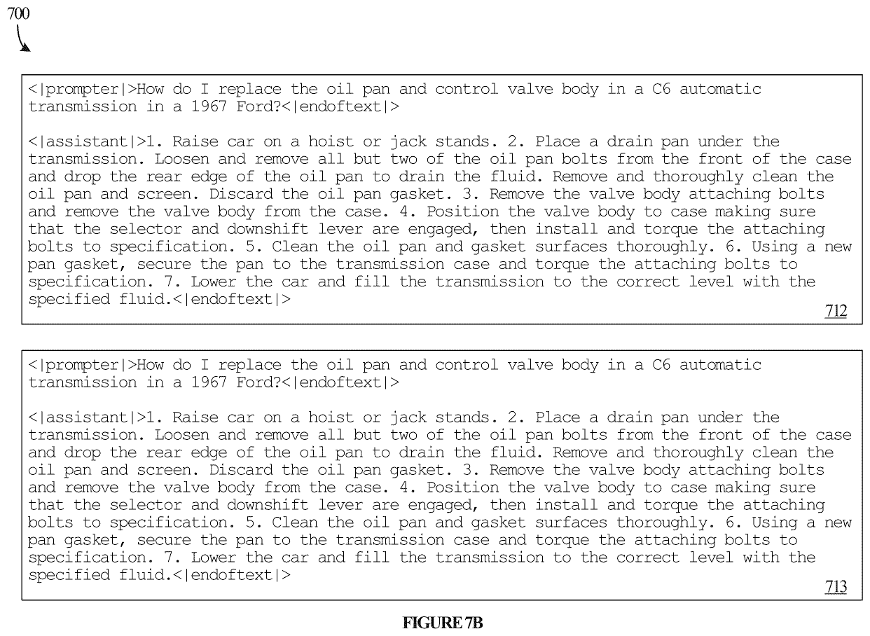

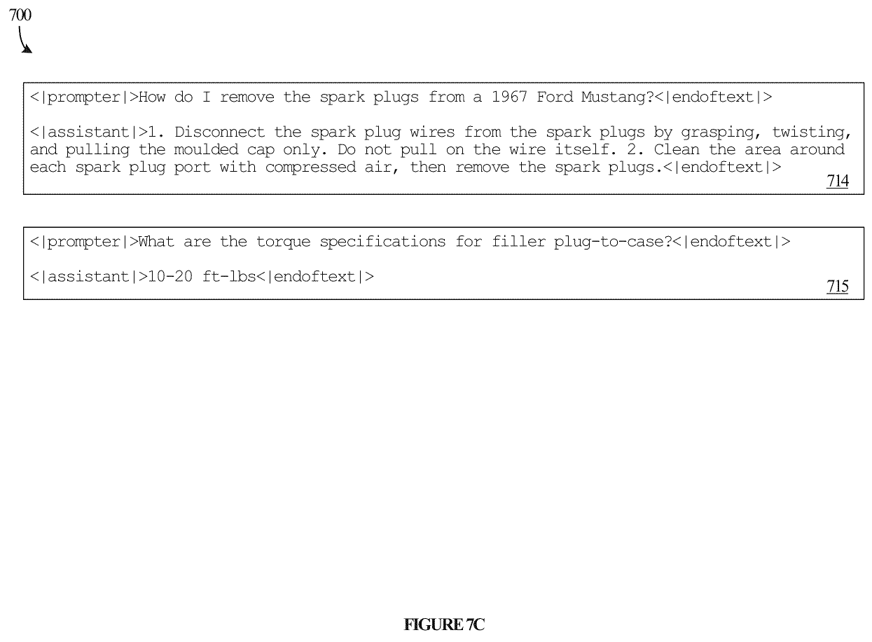

FIGS. 7A, 7B, and 7C illustrate prompt-completion training sets 710-716 for fine-tuning an LLM, such as an LLM of LLM service 121 in FIG. 1. Each of training sets 710-716 include a natural language query (prepended with the identifier “prompter”) which illustrates the type of query that might be submitted by a user and which would be used to generate a response from the LLM regarding some process or procedure to be performed on a vehicle or other mechanical system. For each prompt, each training set also includes a sample response (prepended with the identifier “assistant” which refers to the role or persona of the LLM) which typifies the type and quality of the response to be generated by the LLM. For example, the sample responses include a numbered sequence of steps, each step describing an action or task the user is to perform to complete the procedure.

In various implementations, subsequent to training, the output generated by the LLM is parsed by a natural language processor to generate a step-by-step display of the procedure on the user's computing device (e.g., smartphone). The processor also identifies parts in the steps which are to be depicted by an AR representation of the part on an image of the actual system the user is working on. The processor also identifies in the steps any tools that would be used to perform the step. For example, in training set 711 of FIG. 7A, for step 4, the processor may indicate to the application service that arm bolts and a mounting bolt are to be identified in a captured image using AR silhouettes of those parts. The processor may also identify the tools which are necessary to tighten the arm bolts and the mounting bracket.

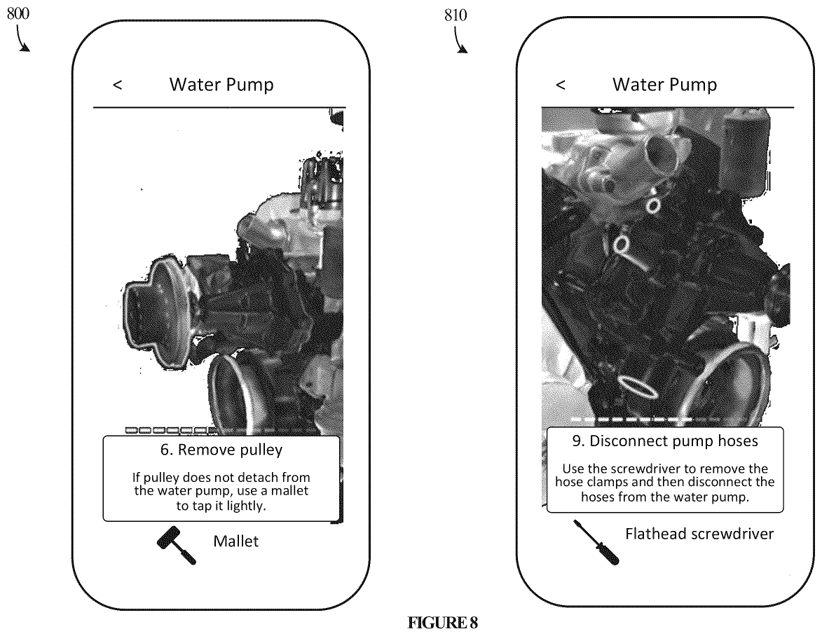

Turning now to FIG. 8, user interfaces 800 and 810 illustrate user experiences of an application service for generating a procedure for a mechanical system including part detection by a trained neural network and AR depiction of detected parts in an implementation. In user interface 800, a step is shown for a procedure to replace a water pump in a 1967 Mustang. A pulley is highlighted in the captured image by means of an AR outline or silhouette of the part. User interface 800 also displays the instruction corresponding to the step and a suggested tool for completing the step. Similarly, in user interface 810, the user is instructed to disconnect pump hoses in the process of replacing the water pump. The locations where the pump hoses are to be disconnected are identified in the captured image by a trained neural network and highlighted by an AR silhouette of the parts or locations.

FIG. 9 illustrates computing device 901 that is representative of any system or collection of systems in which the various processes, programs, services, and scenarios disclosed herein may be implemented. Examples of computing device 901 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 901 may be implemented as a single apparatus, system, or device or may be implemented in a distributed manner as multiple apparatuses, systems, or devices. Computing device 901 includes, but is not limited to, processing system 902, storage system 903, software 905, communication interface system 907, and user interface system 909 (optional). Processing system 902 is operatively coupled with storage system 903, communication interface system 907, and user interface system 909.

Processing system 902 loads and executes software 905 from storage system 903. Software 905 includes and implements object identification process 906, which is (are) representative of the object identification processes discussed with respect to the preceding Figures, such as process 200. When executed by processing system 902, software 905 directs processing system 902 to operate as described herein for at least the various processes, operational scenarios, and sequences discussed in the foregoing implementations. Computing device 901 may optionally include additional devices, features, or functionality not discussed for purposes of brevity.

Referring still to FIG. 9, processing system 902 may comprise a micro-processor and other circuitry that retrieves and executes software 905 from storage system 903. Processing system 902 may be implemented within a single processing device but may also be distributed across multiple processing devices or sub-systems that cooperate in executing program instructions. Examples of processing system 902 include general purpose central processing units, graphical processing units, application specific processors, and logic devices, as well as any other type of processing device, combinations, or variations thereof.

Storage system 903 may comprise any computer readable storage media readable by processing system 902 and capable of storing software 905. Storage system 903 may include volatile and non-volatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 903 may also include computer readable communication media over which at least some of software 905 may be communicated internally or externally. Storage system 903 may be implemented as a single storage device but may also be implemented across multiple storage devices or sub-systems co-located or distributed relative to each other. Storage system 903 may comprise additional elements, such as a controller, capable of communicating with processing system 902 or possibly other systems.

Software 905 (including object identification process 906) may be implemented in program instructions and among other functions may, when executed by processing system 902, direct processing system 902 to operate as described with respect to the various operational scenarios, sequences, and processes illustrated herein. For example, software 905 may include program instructions for implementing an object identification process, including object detection with integrated AR generation as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtualization software, or other application software. Software 905 may also comprise firmware or some other form of machine-readable processing instructions executable by processing system 902.

In general, software 905 may, when loaded into processing system 902 and executed, transform a suitable apparatus, system, or device (of which computing device 901 is representative) overall from a general-purpose computing system into a special-purpose computing system customized to object identification processes in an optimized manner. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon. Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A computing apparatus comprising:
one or more computer-readable storage media;
one or more processors operatively coupled to the one or more computer-readable storage media; and
an application comprising program instructions stored on the one or more computer-readable storage media that, when executed by the one or more processors, direct the computing apparatus to:
display, in a user interface of the application, an image captured by a camera coupled to the computing apparatus, wherein the image includes a part;
detect the part in the image;
generate a parameter set based on a detection of the part in the image; and
display, in a user interface, an augmented reality depiction of the part overlaying the image based on the parameter set.

2. The computing apparatus of claim 1, wherein to detect the part in the image, the program instructions direct the computing apparatus to detect the part in the image using a neural network model, wherein the neural network model is trained based on multiple images of the part and wherein each image of the multiple images comprises an orientation of the part different from others of the multiple images.

3. The computing apparatus of claim 2, wherein to generate the parameter set based on the detection, the program instructions direct the computing apparatus to generate the parameter set using a second neural network model, wherein the second neural network model is trained based on parameter set data corresponding to the multiple images.

4. The computing apparatus of claim 3, wherein the parameter set comprises parameters relating to a position and an orientation of the part based on the detection of the part.

5. The computing apparatus of claim 3, wherein the multiple images of the part are processed to heighten contour shading and flatten one or more surfaces of the part.

6. The computing apparatus of claim 5, wherein at least a subset of the multiple images comprises obstructed views of the part.

7. The computing apparatus of claim 6, wherein at least a second subset of the multiple images comprises a noisy background.

8. The computing apparatus of claim 1, wherein the program instructions further direct the computing apparatus to receive a request to identify the part in the image based on a response from a large language model.

9. The computing apparatus of claim 8, wherein the program instructions further direct the computing apparatus to generate a prompt for the large language model, wherein the prompt tasks the large language model with generating the response including one or more steps of a procedure and wherein the prompt is based on a query received in the user interface of the application.

10. The computing apparatus of claim 9, wherein the program instructions further direct the computing apparatus to generate, by a natural language processor, the procedure based on the response and display the steps of the procedure in the user interface of the application.

11. A method of operating an application, comprising:
displaying, in a user interface of the application, an image captured by a camera, wherein the image includes a part;
detecting the part in the image;
generating a parameter set based on a detection of the part in the image; and
displaying, in a user interface, an augmented reality depiction of the part overlaying the image based on the parameter set.

12. The method of claim 11, wherein detecting the part in the image comprises detecting the part in the image using a neural network model, wherein the neural network model is trained based on multiple images of the part and wherein each image of the multiple images comprises an orientation of the part different from others of the multiple images.

13. The method of claim 12, wherein generating the parameter set for the detection of the part comprises generating the parameter set using a second neural network model, wherein the second neural network model is trained based on parameter set data corresponding to the multiple images.

14. The method of claim 13, wherein the parameter set comprises parameters relating to a position and an orientation of the part based on the detection of the part.

15. The method of claim 14, wherein the multiple images of the part are processed to heighten contour shading and flatten one or more surfaces of the part.

16. The method of claim 15, wherein at least a subset of the multiple images comprises obstructed views of the part and wherein at least a second subset of the multiple images comprises a noisy background.

17. The method of claim 11, further comprising receiving a request to identify the part in the image based on a response from a large language model.

18. The method of claim 17, further comprising generating a prompt for the large language model, wherein the prompt tasks the large language model with generating the response including one or more steps of a procedure and generating, by a natural language processor, the procedure based on the response and displaying the steps of the procedure in the user interface of the application.

19. A method of operating a system for object detection, the system comprising:
a prompt engine;
a natural language processing engine; and
one or more neural network models;
the method comprising:
by the prompt engine:
receiving a query for a procedure relating to a vehicle;
generating a prompt for a large language model based on the query, wherein the prompt includes a request for instructions relating to the query;
responsive to submitting the prompt to the large language model, receiving
the instructions from the large language model based on the prompt; by the natural language processing engine:
parsing the instructions to generate a procedure, wherein the procedure comprises a sequence of steps and wherein at least one step of the sequence steps indicates a part of the vehicle;
by the one or more neural network models:
detecting the part in an image of the vehicle;
generating a parameter set based on a detection of the part in the image; and
generating an augmented reality depiction of the part based on the parameter set.

20. The method of claim 19, wherein the system further comprises an application executing on a computing device, and wherein the method further comprises:
displaying the image of the vehicle in a user interface of the application; and
displaying the augmented reality depiction of the part on the image.
